(19) United States
(12) Patent Application Publication
(10) Pub. No.: US 2018/0179356 A1
(43) Pub. Date: Jun. 28, 2018

(54) PLASTIC SURFACES HAVING ENHANCED HARDNESS AND METHODS OF MAKING THE SAME

(71) Applicant: SABIC Global Technologies B.V., Bergen op Zoom (NL)

(72) Inventors: Jong-Min Choi, Gyeonggi-do (KR); Chunim Lee, Seoul (KR)

(21) Appl. No.: 15/739,227

(22) PCT Filed: Jun. 28, 2016
(86) PCT No.: PCT/IB2016/053858

§ 371 Date: Dec. 22, 2017

Related U.S. Application Data
(60) Provisional application No. 62/187,284, filed on Jul. 1, 2015.

(51) Int. Cl. C08J 7/04

(52) U.S. Cl. CPC C08J 7/047; C08J 2369/00; C08J 2483/06

(57) ABSTRACT

Various embodiments of the present invention relate to plastic surfaces having enhanced hardness and methods of making the same. In various embodiments, the present invention provides a method of enhancing hardness of a plastic surface. The method can include coating a surface of a solid plastic form including a filler, a polyester, or a combination thereof, with a flowable curable coating composition. The method can also include curing the curable coating composition, to provide a hardened film on the solid plastic form surface.

### BACKGROUND

Polycarbonate is often used as an optical material due to its combination of good optical and mechanical properties, light weight, and easy mass production. However, polycarbonate has poor scratch resistance. Various hard-coating materials have been developed, such as melamine-, acrylic-, and urethane-based chemicals. However, even with the use of various coating materials, polycarbonate can only achieve a surface hardness equal to or less than 3H as measured according to ASTM D3363 using 1 kg load.

### SUMMARY OF THE INVENTION

In various embodiments, a method of enhancing hardness of a plastic surface is provided. The method includes coating a surface of a solid plastic form including a filler, a polyester, or a combination thereof, with a flowable curable coating composition. Condition a), condition b), or conditions a) and b) are satisfied. In condition a) the flowable curable coating composition includes an alicyclic epoxy group-containing siloxane resin having a weight average molecular weight of about 1,000 to about 4,000 and a (M_{w}/Mₙ) of about 1.05 to about 1.4. In condition b), the flowable curable coating composition includes an epoxy-functional organosiloxane, an organosiloxane including a isocyanate group or an isocyanurate group, and a bis(organosiloxane)-functional amine. The method also includes curing the curable coating composition, to provide a hardened film on the solid plastic form surface.

In various embodiments, a method of enhancing hardness of a plastic surface is provided. The method includes coating a surface of a solid polycarbonate form including glass fibers, a polyester, or a combination thereof, with a flowable curable coating composition. Condition a), condition b), or conditions a) and b) are satisfied. In condition a) the flowable curable coating composition includes an alicyclic epoxy group-containing siloxane resin having a weight average molecular weight of about 1,000 to about 4,000 and a (M_{w}/Mₙ) of about 1.05 to about 1.4. In condition b), the flowable curable coating composition includes an epoxy-functional organosiloxane, an organosiloxane including a isocyanate group or an isocyanurate group, and a bis(organosiloxane)-functional amine. The solid polycarbonate form is about 50 wt % to about 100 wt % polycarbonate. The method also includes curing the curable coating composition, to provide a hardened film on the solid polycarbonate form surface having a hardness of about 3B to about 9H.

In various embodiments, a solid plastic form having enhanced surface hardness is provided. The polycarbonate form includes a hardened film on a surface of the solid plastic form including a cured reaction product of a flowable curable coating composition. Condition a), condition b), or conditions a) and b) are satisfied. In condition a) the flowable curable coating composition includes an alicyclic epoxy group-containing siloxane resin having a weight average molecular weight of about 1,000 to about 4,000 and a (M_{w}/Mₙ) of about 1.05 to about 1.4. In condition b), the flowable curable coating composition includes an epoxy-functional organosiloxane, an organosiloxane including a isocyanate group or an isocyanurate group, and a bis(organosiloxane)-functional amine. The solid plastic form includes a filler, a polyester, or a combination thereof, and the hardened film on the surface of the solid plastic form has a hardness of about 3B to about 9H.

In various embodiments, the present invention provides certain advantages over other plastic surfaces having enhanced hardness, and methods of making the same, at least some of which are unexpected. In various embodiments, the solid polycarbonate form having enhanced surface hardness can have a harder surface than other polycarbonates, such as other coated polycarbonates. In various embodiments, the solid polycarbonate form having enhanced surface hardness can have greater scratch resistance than other polycarbonates, such as other coated polycarbonates. In various embodiments, the solid polycarbonate form having enhanced surface hardness can have a smoother and glass-like surface texture than other polycarbonates, such as other coated polycarbonates. In various embodiments, the solid polycarbonate form having enhanced surface hardness can have better optical qualities than other coated polycarbonates. In various embodiments, the hardened film on the solid polycarbonate form having enhanced surface hardness can have better adhesion to the solid polycarbonate form than other polycarbonate coatings.

### DETAILED DESCRIPTION OF THE INVENTION

A surface of a solid plastic form including a filler, a polyester, or a combination thereof, can be coated with a flowable curable coating composition. The curable coating composition can be cured to provide a hardened film on the solid plastic form surface. The hardened film can provide a hard an abrasion resistant coating layer. The hardened film can provide high surface hardness and a glass-like feel, and can provide a desirable combination of properties such as hardness, scratch resistance, mechanical strength, and impact resistance. The filler, polyester, or combination thereof, can produce a surprising increase in hardness as compared to the results of the treatment as performed on a solid plastic form free of filler and polyester.

The method can include coating a surface of a solid plastic form with a flowable curable coating composition. The coating can be performed in any suitable manner that forms a coating of the flowable curable coating composition on a surface of the solid plastic form. Wet or transfer coating methods can be used. For example, the coating can be bar coating, spin coating, spray coating, or dipping. Single- or multiple-side coating can be performed.

The solid plastic form can be transparent, opaque, or any one or more colors. The solid plastic form can include any one or more suitable plastics (e.g., as a homogeneous mixture of plastics). In some embodiments, the solid plastic form can include at least one of an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN). In some embodiments, the solid plastic form includes at least one of polycarbonate polymer (PC) and polymethylmethacrylate polymer (PMMA). The solid plastic form can include a blend of PC and PMMA.

The solid plastic form can include one type of polycarbonate or multiple types of polycarbonate. The polycarbonate can be made via interfacial polymerization (e.g., reaction of bisphenol with phosgene at an interface between an organic solution such as methylene chloride and a caustic aqueous solution) or melt polymerization (e.g., transesterification and/or polycondensation of monomers or oligomers above the melt temperature of the reaction mass). Although the reaction conditions for interfacial polymerization may vary, in an example the procedure can include dissolving or dispersing a dihydric phenol reactant in aqueous caustic soda or potash, adding the resulting mixture to a suitable water-immiscible solvent medium, and contacting the reactants with a carbonate precursor (e.g., phosgene) in the presence of a catalyst such as triethylamine or a phase transfer catalyst, under controlled pH conditions, e.g., about 8 to about 10. The most commonly used water-immiscible solvents include methylene chloride, 1,2-dichloroethane, chlorobenzene, toluene, and the like.

Alternatively, melt processes may be used to make the polycarbonates. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a mixer, twin screw extruder, or the like, to form a uniform dispersion. Volatile monohydric phenol can be removed from the molten reactants by distillation and the polymer can be isolated as a molten residue. In some embodiments, a melt process for making polycarbonates uses a diaryl carbonate ester having electron-withdrawing substituents on the aryl groups, such as bis(4-nitrophenyl)carbonate, bis(2-chlorophenyl)carbonate, bis(4-chlorophenyl)carbonate, bis(methyl salicyl)carbonate, bis(4-methylcarboxylphenyl)carbonate, bis(2-acetylphenyl)carboxylate, bis(4-acetylphenyl)carboxylate, or a combination thereof. In addition, transesterification catalysts for use may include phase transfer catalysts such as tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination thereof.

The one or more polycarbonates can be about 50 wt % to about 100 wt % of the solid plastic form, such as about 50 wt % or less, or about 55 wt %, 60, 65, 70, 75, 80, 85, 90, 95, 96, 97, 98, 99, 99.9 wt %, or about 99.99 wt % or more. In various embodiments, the polycarbonate can include a repeating group having the structure:

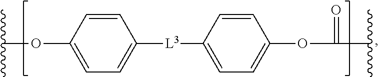

Each phenyl ring in the structure is independently substituted or unsubstituted. The variable L³ is chosen from —S(O)₂— and substituted or unsubstituted (C₁-C₂₀) hydrocarbylene. In various embodiments, the polycarbonate can be derived from bisphenol A, such that the polycarbonate includes a repeating group having the structure:

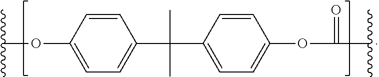

The solid plastic form can include a filler, such as one filler or multiple fillers. The filler can be any suitable type of filler. The filler can be homogeneously distributed in the solid plastic form. The one or more fillers can form about 0.001 wt % to about 50 wt % of the solid plastic form, or about 0.01 wt % to about 30 wt %, or about 0.001 wt % or less, or about 0.01 wt %, 0.1, 1, 2, 3, 4, 5, 10, 15, 20, 25, 30, 35, 40, 45 wt %, or about 50 wt % or more. The filler can be fibrous or particulate. The filler can be aluminum silicate (mullite), synthetic calcium silicate, zirconium silicate, fused silica, crystalline silica graphite, natural silica sand, or the like; boron powders; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres; kaolin; single crystal fibers or “whiskers” such as silicon carbide, alumina, boron carbide, iron, nickel, copper, or the like; fibers (including continuous and chopped fibers) such as asbestos, carbon fibers, glass fibers; sulfides such as molybdenum sulfide, zinc sulfide, or the like; barium compounds; metals and metal oxides such as particulate or fibrous materials; flaked fillers; fibrous fillers, for example short inorganic fibers such as those derived from blends including at least one of aluminum silicates, aluminum oxides, magnesium oxides, and calcium sulfate hemihydrate or the like; natural fillers and reinforcements; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; or combinations including at least one of the foregoing fillers. The filler can be selected from glass fibers, carbon fibers, a mineral fillers, or combinations thereof. The filler can be glass fibers.

The glass fibers can be selected from E-glass, S-glass, AR-glass, T-glass, D-glass, R-glass, and combinations thereof. The glass fibers used can be selected from E-glass, S-glass, and combinations thereof. High-strength glass is generally known as S-type glass in the United States, R-glass in Europe, and T-glass in Japan. High-strength glass has appreciably higher amounts of silica oxide, aluminum oxide and magnesium oxide than E-glass. S-2 glass is approximately 40-70% stronger than E-glass. The glass fibers can be made by standard processes, e.g., by steam or air blowing, flame blowing, and mechanical pulling.

The glass fibers can be sized or unsized. Sized glass fibers are coated on their surfaces with a sizing composition selected for compatibility with the polycarbonate. The sizing composition facilitates wet-out and wet-through of the polycarbonate on the fiber strands and assists in attaining desired physical properties in the polycarbonate composition. The glass fibers can be sized with a coating agent. The coating agent can be present in an amount from about 0.1 wt % to about 5 wt %, or about 0.1 wt % to about 2 wt %, based on the weight of the glass fibers.

In preparing the glass fibers, a number of filaments can be formed simultaneously, sized with the coating agent and then bundled into what is called a strand. Alternatively the strand itself may be first formed of filaments and then sized. The amount of sizing employed is generally that amount which is sufficient to bind the glass filaments into a continuous strand and can be about 0.1 to about 5 wt %, about 0.1 to 2 wt %, or about 1 wt %, based on the weight of the glass fibers.

The glass fibers can be continuous or chopped. Glass fibers in the form of chopped strands may have a length of about 0.3 mm to about 10 cm, about 0.5 cm to about 5 cm, or about 1.0 mm to about 2.5 cm. In various further aspects, the glass fibers can have a length of about 0.2 mm to about 20 mm, about 0.2 mm to about 10 mm, or about 0.7 mm to about 7 mm, 1 mm or longer, or 2 mm or longer. The glass fibers can have a round (or circular), flat, or irregular cross-section. The diameter of the glass fibers can be about 1 μm to about 15 μm, about 4 to about 10 μm, about 1 μm to about 10 μm, or about 7 μm to about 10 μm.

The solid plastic form can include a polyester. The polyester can be any suitable polyester. The polyester can be chosen from aromatic polyesters, poly(alkylene esters) including poly(alkylene arylates) (e.g., poly(alkylene terephthalates)), and poly(cycloalkylene diesters) (e.g., poly(cycloghexanedimethylene terephthalate) (PCT), or poly(1,4-cyclohexane-dimethanol-1,4-cyclohexanedicarboxylate) (PCCD)), and resorcinol-based aryl polyesters. The polyester can be poly(isophthalate-terephthalate-resorcinol)esters, poly(isophthalate-terephthalate-bisphenol A)esters, poly[(isophthalate-terephthalate-resorcinol)ester-co-(isophthalate-terephthalate-bisphenol A)]ester, or a combination including at least one of these. Examples of poly(alkylene terephthalates) include poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). Copolymers including alkylene terephthalate repeating ester units with other ester groups can also be useful. Useful ester units can include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer includes greater than or equal to 50 mol % of poly(ethylene terephthalate), and abbreviated as PCTG where the polymer includes greater than 50 mol % of poly(1,4-cyclohexanedimethylene terephthalate). The polyester can be substantially homogeneously distributed in the solid plastic form. The solid plastic form can include one type of polyester or multiple types of polyester. The one or more polyesters can form any suitable proportion of the solid plastic form, such as about 0.001 wt % to about 50 wt % of the solid plastic form, about 0.01 wt % to about 30 wt %, or about 0.001 wt % or less, or about 0.01 wt %, 0.1, 1, 2, 3, 4, 5, 6, 8, 10, 12, 14, 16, 18, 20, 22, 24, 26, 28, 30, 35, 40, 45 wt %, or about 50 wt % or more. The polyester can includes a repeating unit having the structure:

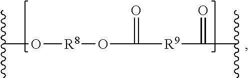

The variables R⁸ and R⁹ can be independently substituted or unsubstituted (C₁-C₂₀) hydrocarbylene. The variables R⁸ and R⁹ can be cycloalkylene-containing groups or aryl-containing groups. The variables R⁸ and R⁹ can be independently substituted or unsubstituted phenyl, or substituted or unsubstituted —(C₀-C₁₀)hydrocarbyl-(C₄-C₁₀)cycloalkyl-(C₀-C₁₀) hydrocarbyl-. The variables R⁸ and R⁹ can both be cycloalkylene-containing groups. The variables R⁸ and R⁹ can independently have the structure:

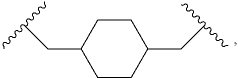 [SMILES: *CC1CCC(C*)CC1]

wherein the cyclohexylene can be substituted in a cis or trans fashion. In some examples, R9 can be a para-substituted phenyl, such that R⁹ appears in the polyester structure as:

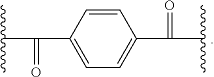 [SMILES: *C(=O)c1ccc(C(*)=O)cc1]

The solid plastic form can have any suitable shape and size. In some embodiments, the solid plastic form is a sheet having any suitable thickness, such as a thickness of about 25 micrometers to about 50,000 micrometers, about 25 micrometers to about 15,000 micrometers, about 60 micrometers to about 800 micrometers, or about 25 micrometers or less, or about 50, 75, 100, 150, 200, 250, 300, 400, 500, 600, 700, 800, 900, 1,000, 1,500, 2,000, 3,000, 4,000, 5,000, 6,000, 8,000, 10,000, 12,000, 14,000, 15,000, 20,000, 25,000, 30,000, 40,000, or about 50,000 micrometers or more.

The flowable curable coating composition can include a) an alicyclic epoxy group-containing siloxane resin having a weight average molecular weight of about 1,000 to about 4,000 and a (M_{w}/Mₙ) of about 1.05 to about 1.4, b) an epoxy-functional organosiloxane and an organosiloxane comprising a isocyanate group or an isocyanurate group, or both a) and b).

The epoxy-functional organosiloxane can have the structure:

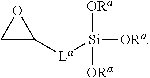

At each occurrence, R^{a} can be independently substituted or unsubstituted (C₁-C₁₀)alkyl. At each occurrence, the variable R^{a} can be independently unsubstituted (C₁-C₆)alkyl. The variable L^{a} can be substituted or unsubstituted (C₁-C₃₀)hydrocarbyl interrupted by 0, 1, 2, or 3 groups independently chosen from —O—, —S—, substituted or unsubstituted —NH—, —(Si(OR^{a})₂)ₙ₁—, —(O—CH₂—CH₂)ₙ₁—, and —(O—CH₂—CH₂—CH₂)ₙ₁—, wherein n1 can be about 1 to about 1,000 (e.g., 1-100, 1-50, 1-10, 1, 2, 3, 4, 5, 6, 8, 10, 12, 14, 16, 18, 20, 25, 30, 40, 50, 75, 100, 200, 250, 500, 750, 1,000). The variable L^{a} can be an unsubstituted (C₁-C₃₀)hydrocarbyl interrupted by 0, 1, 2, or 3 groups independently chosen from —O— and —S—. The epoxy-functional organosiloxane can be 2-(3,4-epoxycyclohexyl)ethyltrimethoxysilane, 3-glycidoxypropyl methyldimethoxysilane, 3-glycidoxypropyl trimethoxysilane, 3-glycidoxypropyl methyldiethoxysilane, or 3-glycidoxypropyl triethoxysilane. The flowable curable resin composition can include one epoxy-functional organosiloxane, or multiple epoxy-functional organosiloxanes. The one or more epoxy-functional organosiloxanes can be any suitable proportion of the flowable curable resin composition such as about 0.01 wt % to about 100 wt %, 10 wt % to about 100 wt %, about 50 wt % to about 99.9 wt %, or about 0.01 wt % or less, or about 0.1 wt %, 1, 2, 3, 4, 5, 6, 8, 10, 12, 14, 15, 20, 25, 30, 35, 40, 45, 50, 55, 60, 65, 70, 75, 80, 85, 90, 95, 96, 97, 98, 99, 99.9, or about 99.99 wt %.

The organosiloxane including an isocyanate group can have the structure (R^{b})₄₋ₚSi(R^{c})ₚ. The variable p can be 1 to 4 (e.g., 1, 2, 3, or 4). At each occurrence, R^{b} can be independently chosen from substituted or unsubstituted (C₁-C₁₀)alkyl and substituted or unsubstituted (C₁-C₁₀)alkoxy. At each occurrence, R^{b} can be independently chosen from unsubstituted (C₁-C₆)alkyl and unsubstituted (C₁-C₆)alkoxy. At each occurrence, R^{c} can be -L^{b}-NCO, wherein L^{b} can be a substituted or unsubstituted (C₁-C₃₀)hydrocarbyl interrupted by 0, 1, 2, or 3 groups independently chosen from —O—, —S—, substituted or unsubstituted —NH—, —(Si(OR^{b})₂)ₙ₂—, —(O—CH₂—CH₂)ₙ₂—, and —(O—CH₂—CH₂—CH₂)ₙ₂—, wherein n2 can be about 1 to about 1,000 (e.g., 1-100, 1-50, 1-10, 1, 2, 3, 4, 5, 6, 8, 10, 12, 14, 16, 18, 20, 25, 30, 40, 50, 75, 100, 200, 250, 500, 750, 1,000). At each occurrence, L^{c} can be an unsubstituted (C₁-C₃₀)hydrocarbyl interrupted by 0, 1, 2, or 3 groups independently chosen from —O— and —S—. The organosiloxane including the isocyanate group can be 3-isocyanatepropyltriethoxysilane. The flowable curable resin composition can include one or more than one organosiloxane including an isocyanate group. The one or more organosiloxanes including an isocyanate group can form any suitable proportion of the flowable curable resin composition, such as about 0.01 wt % to about 100 wt %, 10 wt % to about 100 wt %, about 50 wt % to about 99.9 wt %, or about 0.01 wt % or less, or about 0.1 wt %, 1, 2, 3, 4, 5, 6, 8, 10, 12, 14, 15, 20, 25, 30, 35, 40, 45, 50, 55, 60, 65, 70, 75, 80, 85, 90, 95, 96, 97, 98, 99, 99.9, or about 99.99 wt %.

The organosiloxane including an isocyanurate group can have the structure:

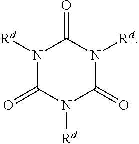

At each occurrence, R^{d} can be chosen from —H and -L^{c}-Si(R^{e})₃, wherein at least one R^{d} is -L^{c}-Si(R^{e})₃. At each occurrence, R^{d} can be -L^{c}-Si(R^{e})₃. At each occurrence, L^{c} can be independently a substituted or unsubstituted (C₁-C₃₀)hydrocarbyl interrupted by 0, 1, 2, or 3 groups independently chosen from —O—, —S—, substituted or unsubstituted —NH—, —(Si(R^{e})₂)ₙ₃—, —(O—CH₂—CH₂)ₙ₃—, and —(O—CH₂—CH₂—CH₂)ₙ₃—, wherein n3 can be about 1 to about 1,000 (e.g., 1-100, 1-50, 1-10, 1, 2, 3, 4, 5, 6, 8, 10, 12, 14, 16, 18, 20, 25, 30, 40, 50, 75, 100, 200, 250, 500, 750, 1,000). At each occurrence, L^{c} can be an unsubstituted (C₁-C₃₀)hydrocarbyl interrupted by 0, 1, 2, or 3 groups independently chosen from —O— and —S—. At each occurrence, R^{e} can be chosen from substituted or unsubstituted (C₁-C₁₀)alkyl and substituted or unsubstituted (C₁-C₁₀)alkoxy. At each occurrence, R^{e} can be independently chosen from unsubstituted (C₁-C₆)alkyl and unsubstituted (C₁-C₆)alkoxy. The organosiloxane including the isocyanate group or isocyanurate group can be tris-[3-(trimethoxysilyl propyl)-isocyanurate. The flowable curable resin composition can include one or multiple organosiloxanes including an isocyanurate group. Any suitable proportion of the flowable curable resin composition can be the one or more organosiloxanes including an isocyanurate group, such as about 0.01 wt % to about 100 wt %, 10 wt % to about 100 wt %, about 50 wt % to about 99.9 wt %, or about 0.01 wt % or less, or about 0.1 wt %, 1, 2, 3, 4, 5, 6, 8, 10, 12, 14, 15, 20, 25, 30, 35, 40, 45, 50, 55, 60, 65, 70, 75, 80, 85, 90, 95, 96, 97, 98, 99, 99.9, or about 99.99 wt %.

The flowable curable resin composition can include a bis(organosiloxane)-functional amine. In some embodiments, the flowable curable resin composition includes an epoxy-functional organosiloxane, an organosiloxane comprising a isocyanate group or an isocyanurate group, and a bis(organosiloxane)-functional amine. The bis(organosiloxane)-functional amine can have the structure R^{f}₃Si-L^{d}-NH-L^{d}-SiR^{f}₃. At each occurrence, R^{f} can be chosen from substituted or unsubstituted (C₁-C₁₀)alkyl and substituted or unsubstituted (C₁-C₁₀)alkoxy. At each occurrence, R^{f} can be independently chosen from unsubstituted (C₁-C₆)alkyl and unsubstituted (C₁-C₆)alkoxy. At each occurrence, L^{d} can be independently a substituted or unsubstituted (C₁-C₃₀)hydrocarbyl interrupted by 0, 1, 2, or 3 groups independently chosen from —O—, —S—, substituted or unsubstituted —NH—, —(Si(R^{f})₂)ₙ₄—, —(O—CH₂—CH₂)ₙ₄—, and —(O—CH₂—CH₂—CH₂)ₙ₄—, wherein n4 can be about 1 to about 1,000 (e.g., 1-100, 1-50, 1-10, 1, 2, 3, 4, 5, 6, 8, 10, 12, 14, 16, 18, 20, 25, 30, 40, 50, 75, 100, 200, 250, 500, 750, 1,000). At each occurrence, L^{d} can be an unsubstituted (C₁-C₃₀)hydrocarbyl interrupted by 0, 1, 2, or 3 groups independently chosen from —O— and —S—. The bis(organosiloxane)-functional amine can be bis(triethoxysilylpropyl)amine, bis(trimethoxysilylpropyl)amine, or bis(methyldiethoxysilylpropyl) amine. The flowable curable resin composition can include one or more bis(organosiloxane)-functional amines. The one or more bis(organosiloxane)-functional amines can form any suitable proportion of the flowable curable resin composition, such as about 0.01 wt % to about 100 wt %, 10 wt % to about 100 wt %, about 50 wt % to about 99.9 wt %, or about 0.01 wt % or less, or about 0.1 wt %, 1, 2, 3, 4, 5, 6, 8, 10, 12, 14, 15, 20, 25, 30, 35, 40, 45, 50, 55, 60, 65, 70, 75, 80, 85, 90, 95, 96, 97, 98, 99, 99.9, or about 99.99 wt %.

The method can include performing a hydrolysis and condensation reaction using water and a catalyst to form a sol (e.g., colloidal suspension), releasing alcohol or water. The sol can include the flowable curable resin composition. Coating the surface of the solid 5 plastic form can include coating the solid plastic form with the sol. Curing the curable coating composition can include curing the sol on the plastic form, to provide the hardened film (e.g., gel) on the solid plastic form surface.

The flowable curable coating composition can include an alicyclic epoxy group-containing siloxane resin. The flowable curable coating composition can include one type of alicyclic epoxy group-containing siloxane resin or multiple types of such resin. The one or more alicyclic epoxy group-containing siloxane resin can form any suitable proportion of the flowable curable coating composition, such as about 0.01 wt % to about 100 wt %, 10 wt % to about 100 wt %, about 50 wt % to about 99.9 wt %, or about 0.01 wt % or less, or about 0.1 wt %, 1, 2, 3, 4, 5, 6, 8, 10, 12, 14, 15, 20, 25, 30, 35, 40, 45, 50, 55, 60, 65, 70, 75, 80, 85, 90, 95, 96, 97, 98, 99, 99.9, or about 99.99 wt %. The siloxane resin can have a weight average molecular weight of about 1,000 to about 4,000 (e.g., about 1,000, 1,200, 1,400, 1,600, 1,800, 2,000, 2,200, 2,400, 2,600, 2,800, 3,000, 3,200, 3,400, 3,600, 3,800, or 4,000) and a (M_{w}/Mₙ) (i.e., weight average molecular weight divided by number average molecular weight, also referred to as polydispersity, a measure of the heterogeneity of sizes of molecules in the mixture) of about 1.05 to about 1.4 (e.g., about 1.05, 1.2, 1.4, 1.6, 1.8, 2.0, 2.2, 2.4, 2.6, 2.8, 3.0, 3.2, 3.4, 3.6, 3.8, or about 4.0 or more).

The siloxane resin can be prepared by hydrolysis and condensation, in the presence of water and an optional catalyst, of (i) an alkoxysilane including an alicyclic epoxy group and an alkoxy group having the structure R¹ₙSi(OR²)₄₋ₙ alone, wherein R¹ is (C₃-C₆)cycloalkyl(C₁-C₆)alkyl wherein the cycloalkyl group includes an epoxy group, R² is (C1-C7)alkyl, and n is 1-3, or (ii) the alkoxysilane having the structure R¹ₙSi(OR²)₄₋ₙ and an alkoxysilane having the structure R³ₘSi(OR⁴)₄₋ₘ, wherein R³ is chosen from (C₁-C₂₀)alkyl, (C₃-C₈)cycloalkyl, (C₂-C₂₀)alkenyl, (C₂-C₂₀)alkynyl, (C₆-C₂₀)aryl, an acryl group, a methacyl group, a halogen group, an amino group, a mercapto group, an ether group, an ester group, a carbonayl group, a carboxyl group, a vinyl group, a nitro group, a sulfone group, and an alkyd group, R⁴ is (C₁-C₇)alkyl, and m is 0 to 3. The alkoxysilxane having the structure R¹ₙSi(OR²)₄₋ₙ can be 2-(3,4-epoxycyclohexyl)ethyltrimethoxysilane or 2-(3,4-epoxycyclohexyl)ethyltriethoxysilane. The alkoxysilane having the structure R³ₘSi(OR⁴)₄₋ₘ can be one or more chosen from tetramethoxysilane, tetraethoxysilane, methyltrimethoxysilane, methyltriethoxysilane, methyltripropoxysilane, dimethyldimethoxysilane, dimethyldiethoxysilane, phenyltrimethoxysilane, phenyltriethoxysilane, diphenyldimethoxysilane, diphenyldiethoxysilane, triphenylmethoxysilane, triphenylethoxysilane, ethyltriethoxysilane, propylethyltrimethoxysilane, vinyltrimethoxysilane, vinyltriethoxysilane, vinyltripropoxysilane, N-(3-acryloxy-2-hydroxypropyl)-3-aminopropyltrimethoxysilane, N-(3-acryloxy-2-hydroxypropyl)-3-aminopropyltriethoxysilane, N-(3-acryloxy-2-hydroxypropyl)-3-aminopropyltripropoxysilane, 3-acryloxypropylmethylbis (trimethoxy) silane, 3-acryloxypropyltrimethoxysilane, 3-acryloxypropyltriethoxysilane, 3-acryloxypropyltripropoxysilane, 3-(meth)acryloxypropyltrimethoxysilane, 3-(meth)acryloxypropyltriethoxysilane, 3-(meth)acryloxypropyltripropoxysilane, N-(aminoethyl-3-aminopropyl)trimethoxysilane, N-(2-aminoethyl-3-aminopropyl)triethoxysilane, 3-aminopropyltrimethoxysilane, 3-aminopropyltriethoxysilane, chloropropyltrimethoxysilane, chloropropyltriethoxysilane, and heptadecafluorodecyltrimethoxysilane.

The flowable curable coating composition can further include a reactive monomer capable of reacting with the alicyclic epoxy group to form crosslinking. The flowable curable coating composition can include one such monomer or multiple such monomers. The one or more reactive monomers can form any suitable proportion of the flowable curable coating composition, such as about 0.001 wt % to about 30 wt %, or about 0.01 wt % to about 10 wt %, or about 0.001 wt % or less, or about 0.01 wt %, 0.1, 1, 2, 3, 4, 5, 6, 8, 10, 12, 14, 16, 18, 20, 22, 24, 26, 28, or about 30 wt % or more. The one or more reactive monomer can be present in any suitable weight ratio to the epoxy-containing siloxane resin, such as about 1:1000 to about 1:10, or about 1:1000 or less, or about 1:500, 1:250, 1:200, 1:150, 1:100, 1:80, 1:60, 1:40, 1:20, or about 1:10 or more. The reactive monomer can be an acid anhydride monomer, an oxetane monomer, or a monomer having an alicyclic epoxy group as a (C₃-C₆)cycloalkyl group. The acid anhydride monomer can be one or more chosen from phthalic anhydride, tetrahydrophthalic anhydride, hexahydrophthalic anhydride, nadic methyl anhydride, chlorendic anhydride, and pyromellitic anhydride. The oxetane monomer can be one or more chosen from 3-ethyl-3-hydroxymethyloxetane, 2-ethylhexyloxetane, xylene bis oxetane, and 3-ethyl-3[[3-ethyloxetan-3-yl]methoxy]oxetane. The reactive monomer having an alicyclic epoxy group can be one or more chosen from 4-vinylcycloghexene dioxide, cyclohexene vinyl monoxide, (3,4-epoxycyclohexyl)methyl 3,4-epoxycyclohexylcarboxylate, 3,4-epoxycyclohexylmethyl methacrylate, and bis(3,4-epoxycyclohexylmethyl)adipate.

In various embodiments, one or more catalysts are present. In other embodiments, the flowable curable coating composition can be free of catalyst. The catalyst can be any suitable catalyst, such as acidic catalysts, basic catalysts, ion exchange resins, and combinations thereof. For example, the catalyst can be hydrochloric acid, acetic acid, hydrogen fluoride, nitric acid, sulfuric acid, chlorosulfonic acid, iodic acid, pyrophosphoric acid, ammonia, potassium hydroxide, sodium hydroxide, barium hydroxide, imidazole, and combinations thereof.

The curable flowable coating composition can include one or more organic solvents, such as in an amount of about 0.01 to about 10 parts by weight, based on 100 parts by weight of the siloxane resin, or about 0.1 to about 10 parts by weight. The one or more solvents can be about 0.001 wt % to about 50 wt % of the curable flowable coating composition, about 0.01 wt % to about 30 wt %, about 30 wt % to about 70 wt %, or about 0.001 wt % or less, or about 0.01 wt %, 0.1, 1, 2, 3, 4, 5, 6, 8, 10, 12, 14, 16, 18, 20, 22, 24, 26, 28, 30, 35, 40, 45 wt %, or about 50 wt % or more.

The flowable curable coating composition can further includes one or more polymerization initiators chosen from UV initiators, thermal initiators, onium salts, organometallic salts, amines, and imidazoles in an amount of about 0.01 to about 10 parts by weight, based on 100 parts by weight of the siloxane resin, or about 0.1 to about 10 parts by weight. The one or more polymerization initiators can be about 0.001 wt % to about 50 wt % of the curable flowable coating composition, about 0.01 wt % to about 30 wt %, or about 0.001 wt % or less, or about 0.01 wt %, 0.1, 1, 2, 3, 4, 5, 6, 8, 10, 12, 14, 16, 18, 20, 22, 24, 26, 28, 30, 35, 40, 45 wt %, or about 50 wt % or more.

The flowable curable coating composition can further include one or more additives, such as chosen from an antioxidant, a leveling agent, an antifogging agent, an antifouling agent, and a coating control agent.

The method can also include curing the curable coating composition, to provide a hardened film on the solid plastic form surface. The curing can be any suitable curing. The curing can be thermal curing. The curing can be UV curing. The curing can be a combination of thermal and UV curing (e.g., in parallel or sequential).

The hardened film in the solid plastic form can have any suitable thickness, such as about 1 micrometer to about 1,000 micrometers, about 1 micrometer to about 100 micrometers, about 5 micrometers to about 75 micrometers, or about 1 micrometer, 2, 3, 4, 5, 6, 8, 10, 12, 14, 16, 18, 20, 25, 30, 35, 40, 45, 50, 55, 60, 65, 70, 75, 80, 85, 90, 95, 100, 200, 500, 750, or about 1,000 micrometers or more.

The hardened film on the solid plastic form surface can have any suitable hardness. For example, the hardened film on the solid plastic form surface can have a hardness of about 3B to about 9H, or about HB to about 8H, or about 3B or less, or about 2B, B, HB, F, H, 2H, 3H, 4H, 5H, 6H, 7H, 8H, or about 9H or more.

A solid plastic form having enhanced surface hardness can be any suitable coated solid plastic form made using an embodiment of the method for forming a solid plastic form having enhanced surface hardness described herein.

In various embodiments the solid plastic form having enhanced surface hardness can be used as a glass replacement in any suitable application. Various embodiments provide a mobile phone component (e.g., a mobile phone plastic cover window having a flat or curved shape, or a mobile phone housing), a television component (e.g., a television bezel), an appliance component (e.g., an appliance housing, such a vacuum cleaner housing, a clothes washer housing, a dish washer housing, a freezer housing), an automobile component (e.g., a sunroof or a moonroof), a window (e.g., a glass-replacement solution for building and construction), a display film, an anti-scattering film or sheet, or a combination thereof, including an embodiment of the solid plastic form having enhanced surface hardness.

### EXAMPLES

Various embodiments of the present invention can be better understood by reference to the following Examples which are offered by way of illustration. The present invention is not limited to the Examples given herein.

### Example 1. Preparation of Coated Articles

For the base articles, four different types were selected such as polycarbonate (PC) (LEXAN™ LS1, a bisphenol A (BPA) polycarbonate), PC with glass fibers (LEXAN™ EXL4419, a BPA polycarbonate with 9 wt % glass fibers), PC modified with polyester (XYLEX™ 7300, a BPA polycarbonate with 30-40 wt % cycloaliphatic polyester), PC with glass fibers and polyester (XYLEX™ EXCY 0477, a BPA polycarbonate with 20-30 wt % cycloaliphatic polyester and 15% glass fibers). Base articles having a thickness of 1.5 mm were used for each type of article. Base articles of PC with glass fibers and polyester (XYLEX™ EXCY 0477) having a thickness of 2.5 mm and 3.5 mm were also used.

The coating composition was DG series, sold by HK Networks Co. Ltd. The same coating composition was used for all of the coated samples.

The coating composition was wet coated on the base article using bar coating. The wet coating had a thickness of 45.5 micrometers. The coating was dried at 60° C. for 10 minutes.

The coating composition was cured using UV curing at 700 milliJoules (mJ) for 20-30 seconds. The cured coating was aged at 60° C. for 60 minutes. The cured coating had a thickness of 25 micrometers.

### Example 2. Testing of Surface Hardness and Adhesion of Hardened Film

Hardness was tested using ASTM D3363, using 1 kg load. The hardness test included five repeated measurements by the pencil hardness test procedure, with the pencil hardness being the hardness of the pencil used for the test when none of the measurements result in scratches or other disturbances to the appearance. For example, if a 3H pencil is used for five test procedures and no appearance disturbances occur, then the pencil hardness of the material is at least 3H. Pencil hardness is measured on the scale of 9B (softest), 8B, 7B, 6B, 5B, 4B, 3B, 2B, B, HB, F, H, 2H, 3H, 4H, 5H, 6H, 7H, 8H, 9H (hardest).

Adhesion between the hardened film and the base article was measured using ASTM D3002. The test is performed by making a series of cuts in the coating in a grid pattern. The adhesion is classified based on the level of flaking or detachment of the coating that occurs in the squares of the grid. For ISO Class 0/ASTM Class 5B, the edges of the cuts are completely smooth, with none of the squares of the lattice detached. For ISO Class 1/ASTM Class 4B, detachment of small flakes of the coating at the intersection of the cuts occurs, with a cross-cut area not significantly greater than 5% being affected. For ISO Class 2/ASTM Class 3B, the coating has flaked along the edges and/or at the intersections of the cuts, with a cross-cut area significantly greater than 5% but no significantly greater than 15%, being affected. For ISO Class 3/ASTM Class 2B, the coating has flaked along the edges of the cutes partly or wholly in large ribbons, and/or it has flaked partly or wholly on different parts of the squares, with a cross-cut area significantly greater than 15%, but not significantly greater than 35%, being affected. For ISO Class 4/ASTM Class 1B, the coating has flaked along the edges of the cuts in large ribbons, and/or some squares have detached partly or wholly. A cross-cut area significantly greater than 35%, but not significantly greater than 65%, is affected. For ISO Class 5/ASTM Class 0B, any degree of flaking occurred that cannot even be classified by ISO classification 4/ASTM Class 1B.

The four base articles of Example 1 having a thickness of 1.5 mm were tested with no coating (samples 1-4), with a coating (samples 5-8), and the base articles of Example 1 having thicknesses of 2.5 mm and 3.5 mm were tested with a coating (samples 9-10). The results are illustrated in Table 1.

TABLE 1
Hardness and adhesion of hardened film.

| | | | | Pencil | |
|---|---|---|---|---|---|
| | | | | hardness | |
| | | Thickness | | (ASTM | Adhesion |
| | Base layer | of | Coating | D3363, | (ASTM |
| No | composition | base layer | layer | 1 Kg) | D3002) |
| 1 | PC | 1.5 mm | no | 6B | — |
| 2 | PC with glass fiber | 1.5 mm | no | 6B | — |
| 3 | Polyester modified | 1.5 mm | no | 6B | — |
| | PC | | | | |
| 4 | Polyester modified | 1.5 mm | no | 4B | — |
| | PC with glass fiber | | | | |
| 5 | PC | 1.5 mm | yes | HB | 4B |
| 6 | PC with glass fiber | 1.5 mm | yes | 5H | 4B |
| 7 | Polyester modified | 1.5 mm | yes | 5H | 4B |
| | PC | | | | |
| 8 | Polyester modified | 1.5 mm | yes | 8H | 3B-4B |
| | PC with glass fiber | | | | |
| 9 | Polyester modified | 2.5 mm | yes | 8H | 3B-4B |
| | PC with glass fiber | | | | |
| 10 | Polyester modified | 3.5 mm | yes | 8H | 3B-4B |
| | PC with glass fiber | | | | |

The hardness and adhesion results can lead to the following conclusions: (1) pure aromatic polycarbonate can increase the surface hardness through functional coating up to pencil hardness of HB; (2) polycarbonate filled with glass fibers can sharply improve the surface hardness to pencil hardness of 5H through functional coating; (3) polyester modified with polycarbonate also can reach to 5H through coating; and (4) polyester modified with polycarbonate filled with glass fibers can dramatically enhance the surface hardness to 8H through functional coating.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

The following exemplary embodiments are provided, the numbering of which is not to be construed as designating levels of importance:

Embodiment 1 provides a method of enhancing hardness of a plastic surface, the method comprising:

coating a surface of a solid plastic form comprising a filler, a polyester, or a combination thereof, with a flowable curable coating composition comprising
a) an alicyclic epoxy group-containing siloxane resin having a weight average molecular weight of about 1,000 to about 4,000 and a (M_{w}/Mₙ) of about 1.05 to about 1.4,
b) an epoxy-functional organosiloxane and an organosiloxane comprising a isocyanate group or an isocyanurate group, or
both a) and b); and

curing the curable coating composition, to provide a hardened film on the solid plastic form surface.

Embodiment 2 provides the method of Embodiment 1, wherein the epoxy-functional organosiloxane has the structure:

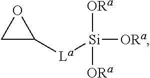

wherein
at each occurrence, R^{a} is independently substituted or unsubstituted (C₁-C₁₀) alkyl,
L^{a} is substituted or unsubstituted (C₁-C₃₀)hydrocarbyl interrupted by 0, 1, 2, or 3 groups independently chosen from —O—, —S—, substituted or unsubstituted —NH—, —(Si(OR^{a})₂)ₙ₁—, —(O—CH₂—CH₂)ₙ₁—, and —(O—CH₂—CH₂—CH₂)ₙ₁—, wherein n1 is about 1 to about 1,000.

Embodiment 3 provides the method of Embodiment 2, wherein at each occurrence R^{a} is independently unsubstituted (C₁-C₆)alkyl.

Embodiment 4 provides the method of any one of Embodiments 2-3, wherein L^{a} is an unsubstituted (C₁-C₃₀)hydrocarbyl interrupted by 0, 1, 2, or 3 groups independently chosen from —O— and —S—.

Embodiment 5 provides the method of any one of Embodiments 1-4, wherein the epoxy-functional organosiloxane is 2-(3,4-epoxycyclohexyl)ethyltrimethoxysilane, 3-glycidoxypropyl methyldimethoxysilane, 3-glycidoxypropyl trimethoxysilane, 3-glycidoxypropyl methyldiethoxysilane, or 3-glycidoxypropyl triethoxysilane.

Embodiment 6 provides the method of any one of Embodiments 1-5, wherein the epoxy-functional organosiloxane is about 0.01 wt % to about 99.99 wt % of the flowable curable coating composition.

Embodiment 7 provides the method of any one of Embodiments 1-6, wherein the organosiloxane comprising an isocyanate group has the structure (R^{b})₄₋ₚSi(R^{c})ₚ, wherein

p is 1 to 4,

at each occurrence, R^{b} is independently chosen from substituted or unsubstituted (C₁-C₁₀) alkyl and substituted or unsubstituted (C₁-C₁₀)alkoxy, and

at each occurrence, R^{c} is -L^{b}-NCO, wherein L^{b} is a substituted or unsubstituted (C₁-C₃₀) hydrocarbyl interrupted by 0, 1, 2, or 3 groups independently chosen from —O—, —S—, substituted or unsubstituted —NH—, —(Si(OR^{b})₂)ₙ₂—, —(O—CH₂—CH₂)ₙ₂—, and —(O—CH₂—CH₂—CH₂)ₙ₂—, wherein n2 is about 1 to about 1,000.

Embodiment 8 provides the method of Embodiment 7, wherein at each occurrence, R^{b} is independently chosen from unsubstituted (C₁-C₆)alkyl and unsubstituted (C₁-C₆)alkoxy.

Embodiment 9 provides the method of any one of Embodiments 7-8, wherein at each occurrence, L^{b} is an unsubstituted (C₁-C₃₀)hydrocarbyl interrupted by 0, 1, 2, or 3 groups independently chosen from —O— and —S—.

Embodiment 10 provides the method of any one of Embodiments 1-9, wherein the organosiloxane comprising an isocyanurate group has the structure:

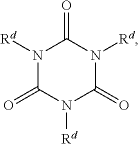

wherein
at each occurrence, R^{d} is chosen from —H and -L^{c}-Si(R^{e})₃, wherein at least one R^{d} is -L^{c}-Si(R^{e})₃,
at each occurrence, L^{c} is independently a substituted or unsubstituted (C₁-C₃₀)hydrocarbyl interrupted by 0, 1, 2, or 3 groups independently chosen from —O—, —S—, substituted or unsubstituted —NH—, —(Si(R^{e})₂)ₙ₃—, —(O—CH₂—CH₂)ₙ₃—, and —(O—CH₂—CH₂—CH₂)ₙ₃—, wherein n3 is about 1 to about 1,000, and
at each occurrence, R^{e} is chosen from substituted or unsubstituted (C₁-C₁₀)alkyl and substituted or unsubstituted (C₁-C₁₀)alkoxy.

Embodiment 11 provides the method of Embodiment 10, wherein at each occurrence, R^{d} is -L^{c}-Si(R^{e})₃.

Embodiment 12 provides the method of any one of Embodiments 10-11, wherein at each occurrence, L^{c} is an unsubstituted (C₁-C₃₀)hydrocarbyl interrupted by 0, 1, 2, or 3 groups independently chosen from —O— and —S—.

Embodiment 13 provides the method of any one of Embodiments 10-12, wherein at each occurrence, R^{e} is independently chosen from unsubstituted (C₁-C₆)alkyl and unsubstituted (C₁-C₆)alkoxy.

Embodiment 14 provides the method of any one of Embodiments 1-13, wherein the organosiloxane comprising an isocyanate group or isocyanurate group is 3-isocyanatepropyltriethoxysilane or tris-[3-(trimethoxysilyl propyl)-isocyanurate.

Embodiment 15 provides the method of any one of Embodiments 1-14, wherein the organosiloxane comprising an isocyanate group or isocyanurate group is about 0.01 wt % to about 99.99 wt % of the flowable curable coating composition.

Embodiment 16 provides the method of any one of Embodiments 1-15, wherein the bis(organosiloxane)-functional amine has the structure R^{f}₃Si-L^{d}-NH-L^{d}-SiR^{f}₃, wherein

at each occurrence, R^{f} is chosen from substituted or unsubstituted (C₁-C₁₀)alkyl and substituted or unsubstituted (C₁-C₁₀)alkoxy, and

at each occurrence, L^{d} is independently a substituted or unsubstituted (C₁-C₃₀)hydrocarbyl interrupted by 0, 1, 2, or 3 groups independently chosen from —O—, —S—, substituted or unsubstituted —NH—, —(Si(R^{f})₂)ₙ₄—, —(O—CH₂—CH₂)ₙ₄—, and —(O—CH₂—CH₂—CH₂)ₙ₄—, wherein n4 is about 1 to about 1,000.

Embodiment 17 provides the method of Embodiment 16, wherein at each occurrence, R^{f} is independently chosen from unsubstituted (C₁-C₆)alkyl and unsubstituted (C₁-C₆)alkoxy.

Embodiment 18 provides the method of any one of Embodiments 16-17, wherein at each occurrence, L^{d} is an unsubstituted (C₁-C₃₀)hydrocarbyl interrupted by 0, 1, 2, or 3 groups independently chosen from —O— and —S—.

Embodiment 19 provides the method of any one of Embodiments 1-18, wherein the bis(organosiloxane)-functional amine is bis(triethoxysilylpropyl)amine, bis(trimethoxysilylpropyl)amine, or bis(methyldiethoxysilylpropyl) amine.

Embodiment 20 provides the method of any one of Embodiments 1-19, wherein the bis(organosiloxane)-functional amine is about 0.01 wt % to about 99.99 wt % of the flowable curable coating composition.

Embodiment 21 provides the method of any one of Embodiments 1-20, wherein the siloxane resin is a hydrolysis and condensation reaction product of

(i) an alkoxysilane comprising an alicyclic epoxy group and an alkoxy group having the structure R¹ₙSi(OR²)₄₋ₙ alone, wherein R¹ is (C₃-C₆)cycloalkyl(C₁-C₆)alkyl wherein the cycloalkyl group comprises an epoxy group, R² is (C₁-C₇)alkyl, and n is 1-3, or

(ii) the alkoxysilane having the structure R¹ₙSi(OR²)₄₋ₙ and an alkoxysilane having the structure R³ₘSi(OR⁴)₄₋ₘ, wherein R³ is chosen from (C₁-C₂₀)alkyl, (C₃-C₈)cycloalkyl, (C₂-C₂₀)alkenyl, (C₂-C₂0)alkynyl, (C₆-C₂₀)aryl, an acryl group, a methacyl group, a halogen group, an amino group, a mercapto group, an ether group, an ester group, a carbonayl group, a carboxyl group, a vinyl group, a nitro group, a sulfone group, and an alkyd group, R⁴ is (C₁-C₇)alkyl, and m is 0 to 3,

wherein hydrolysis and condensation reaction is carried out in the presence of water and an optional catalyst.

Embodiment 22 provides the method of Embodiment 21, wherein the alkoxysilxane having the structure R¹ₙSi(OR²)₄₋ₙ is 2-(3,4-epoxycyclohexyl)ethyltrimethoxysilane or 2-(3,4-epoxycyclohexyl)ethyltriethoxysilane.

Embodiment 23 provides the method of any one of Embodiments 21-22, wherein the alkoxysilane having the structure R³ₘSi(OR⁴)₄₋ₘ is one or more chosen from tetramethoxysilane, tetraethoxysilane, methyltrimethoxysilane, methyltriethoxysilane, methyltripropoxysilane, dimethyldimethoxysilane, dimethyldiethoxysilane, phenyltrimethoxysilane, phenyltriethoxysilane, diphenyldimethoxysilane, diphenyldiethoxysilane, triphenylmethoxysilane, triphenylethoxysilane, ethyltriethoxysilane, propylethyltrimethoxysilane, vinyltrimethoxysilane, vinyltriethoxysilane, vinyltripropoxysilane, N-(3-acryloxy-2-hydroxypropyl)-3-aminopropyltrimethoxysilane, N-(3-acryloxy-2-hydroxypropyl)-3-aminopropyltriethoxysilane, N-(3-acryloxy-2-hydroxypropyl)-3-aminopropyltripropoxysilane, 3-acryloxypropylmethylbis (trimethoxy) silane, 3-acryloxypropyltrimethoxysilane, 3-acryloxypropyltriethoxysilane, 3-acryloxypropyltripropoxysilane, 3-(meth)acryloxypropyltrimethoxysilane, 3-(meth)acryloxypropyltriethoxysilane, 3-(meth)acryloxypropyltripropoxysilane, N-(aminoethyl-3-aminopropyl)trimethoxysilane, N-(2-aminoethyl-3-aminopropyl)triethoxysilane, 3-aminopropyltrimethoxysilane, 3-aminopropyltriethoxysilane, chloropropyltrimethoxysilane, chloropropyltriethoxysilane, and heptadecafluorodecyltrimethoxysilane.

Embodiment 24 provides the method of any one of Embodiments 1-23, wherein the flowable curable coating composition further comprises a reactive monomer capable of reacting with the alicyclic epoxy group to form crosslinking.

Embodiment 25 provides the method of Embodiment 24, wherein the reactive monomer is an acid anhydride monomer, an oxetane monomer, or a monomer having an alicyclic epoxy group as a (C₃-C₆)cycloalkyl group.

Embodiment 26 provides the method of Embodiment 25, wherein the acid anhydride monomer is one or more chosen from phthalic anhydride, tetrahydrophthalic anhydride, hexahydrophthalic anhydride, nadic methyl anhydride, chlorendic anhydride, and pyromellitic anhydride.

Embodiment 27 provides the method of any one of Embodiments 25-26, wherein the oxetane monomer is one or more chosen from 3-ethyl-3-hydroxymethyloxetane, 2-ethylhexyloxetane, xylene bis oxetane, and 3-ethyl-3[[3-ethyloxetan-3-yl]methoxy]oxetane.

Embodiment 28 provides the method of any one of Embodiments 25-27, wherein the reactive monomer having an alicyclic epoxy group is one or more chosen from 4-vinylcycloghexene dioxide, cyclohexene vinyl monoxide, (3,4-epoxycyclohexyl)methyl 3,4-epoxycyclohexylcarboxylate, 3,4-epoxycyclohexylmethyl methacrylate, and bis(3,4-epoxycyclohexylmethyl)adipate.

Embodiment 29 provides the method of any one of Embodiments 21-28, wherein the catalyst is present and is chosen from acidic catalysts, basic catalysts, ion exchange resins, and combinations thereof.

Embodiment 30 provides the method of any one of Embodiments 1-29, wherein the flowable curable coating composition further comprises an organic solvent in an amount of about 0.01 to about 10 parts by weight, based on 100 parts by weight of the siloxane resin.

Embodiment 31 provides the method of any one of Embodiments 1-30, wherein the flowable curable coating composition further comprises a polymerization initiator chosen from UV initiators, thermal initiators, onium salts, organometallic salts, amines, and imidazoles in an amount of about 0.01 to about 10 parts by weight, based on 100 parts by weight of the siloxane resin.

Embodiment 32 provides the method of any one of Embodiments 1-31, wherein the flowable curable coating composition further comprises one or more additives chosen from an organic solvent, an antioxidant, a leveling agent, an antifogging agent, an antifouling agent, and a coating control agent.

Embodiment 33 provides the method of any one of Embodiments 1-32, wherein the curing comprises at least one of thermal curing and UV curing.

Embodiment 34 provides the method of any one of Embodiments 1-33, wherein the solid plastic form has a thickness of about 25 micrometers to about 15,000 micrometers.

Embodiment 35 provides the method of any one of Embodiments 1-34, wherein the solid plastic form has a thickness of about 60 micrometers to about 800 micrometers.

Embodiment 36 provides the method of any one of Embodiments 1-35, wherein the hardened film has a thickness of about 1 micrometer to about 100 micrometers.

Embodiment 37 provides the method of any one of Embodiments 1-36, wherein the hardened film has a thickness of about 5 micrometers to about 75 micrometers.

Embodiment 38 provides the method of any one of Embodiments 1-37, wherein the hardened film on the solid plastic form surface has a hardness of about 3B to about 9H.

Embodiment 39 provides the method of any one of Embodiments 1-38, wherein the hardened film on the solid plastic form surface has a hardness of about HB to about 8H.

Embodiment 40 provides the method of any one of Embodiments 1-39, wherein the solid plastic form comprises at least one of an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN).

Embodiment 41 provides the method of any one of Embodiments 1-40, wherein the solid plastic form comprises at least one of polycarbonate polymer (PC) and polymethylmethacrylate polymer (PMMA).

Embodiment 42 provides the method of any one of Embodiments 1-41, wherein the solid plastic form is about 50 wt % to about 100 wt % polycarbonate.

Embodiment 43 provides the method of any one of Embodiments 40-41, wherein the polycarbonate comprises a repeating group having the structure:

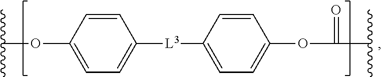

wherein
each phenyl ring is independently substituted or unsubstituted, and
L³ is chosen from —S(O)₂— and substituted or unsubstituted (C₁-C₂₀) hydrocarbylene.

Embodiment 44 provides the method of Embodiment 43, wherein the polycarbonate comprises a repeating group having the structure:

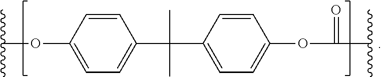

Embodiment 45 provides the method of any one of Embodiments 1-44, wherein the filler is about 0.001 wt % to about 50 wt % of the solid plastic form.

Embodiment 46 provides the method of any one of Embodiments 1-45, wherein the polyester is about 0.001 wt % to about 50 wt % of the solid plastic form.

Embodiment 47 provides the method of any one of Embodiments 1-46, wherein the polyester comprises a repeating unit having the structure:

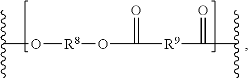

wherein
R⁸ and R⁹ are independently substituted or unsubstituted (C₁-C₂₀) hydrocarbylene.

Embodiment 48 provides the method of Embodiment 47, wherein R⁸ and R⁹ are cycloalkylene-containing or aryl-containing groups.

Embodiment 49 provides the method of any one of Embodiments 47-48, wherein R⁸ and R⁹ independently have the structure:

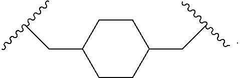 [SMILES: *CC1CCC(C*)CC1]

Embodiment 50 provides a mobile phone component, a television component, an appliance component, an automobile component, a window, a display film, an anti-scattering film or sheet, or a combination thereof, comprising the plastic form comprising the hardened film made by the method of any one of Embodiments 1-49.

Embodiment 51 provides a method of enhancing hardness of a plastic surface, the method comprising:

coating a surface of a solid polycarbonate form comprising glass fibers, a polyester, or a combination thereof, with a flowable curable coating composition, comprising
a) an alicyclic epoxy group-containing siloxane resin having a weight average molecular weight of about 1,000 to about 4,000 and a (M_{w}/Mₙ) of about 1.05 to about 1.4,
b) an epoxy-functional organosiloxane and an organosiloxane comprising a isocyanate group or an isocyanurate group, or
both a) and b); and

curing the curable coating composition, to provide a hardened film on the solid polycarbonate form surface having a hardness of about 3B to about 9H, wherein the solid polycarbonate form is about 50 wt % to about 100 wt % polycarbonate.

Embodiment 52 provides a solid plastic form having enhanced surface hardness, the plastic form comprising:

a hardened film on a surface of the solid plastic form, the hardened film comprising a cured reaction product of a flowable curable coating composition comprising
a) an alicyclic epoxy group-containing siloxane resin having a weight average molecular weight of about 1,000 to about 4,000 and a (M_{w}/Mₙ) of about 1.05 to about 1.4,
b) an epoxy-functional organosiloxane and an organosiloxane comprising a isocyanate group or an isocyanurate group, or
both a) and b);

wherein the solid plastic form comprises a filler, a polyester, or a combination thereof, and the hardened film on the surface of the solid plastic form has a hardness of about 3B to about 9H.

Embodiment 53 provides a mobile phone component, a television component, an appliance component, an automobile component, a window, a display film, an anti-scattering film or sheet, or a combination thereof, comprising solid plastic form having enhanced surface hardness of Embodiment 52.

Embodiment 54 provides the method, solid plastic form, or apparatus of any one or any combination of Embodiments 1-53 optionally configured such that all elements or options recited are available to use or select from.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

Unless specified to the contrary herein, all test standards (including ISO, ASTM, and others) are the most recent standard in effect as of the Jul. 1, 2015.

The term “organic group” as used herein refers to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups.

The term “alkenyl” as used herein refers to straight and branched chain and cyclic alkyl groups as defined herein, except that at least one double bond exists between two carbon atoms.

The term “acyl” as used herein refers to a group containing a carbonyl moiety wherein the group is bonded via the carbonyl carbon atom.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups.

The term “heterocyclyl” as used herein refers to aromatic and non-aromatic ring compounds containing three or more ring members, of which one or more is a heteroatom such as, but not limited to, N, O, and S.

The term “alkoxy” as used herein refers to an oxygen atom connected to an alkyl group, including a cycloalkyl group, as are defined herein.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” or “hydrocarbyl” as used herein refers to a molecule or functional group, respectively, that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b}) hydrocarbyl, wherein a and b are integers and mean having any of a to b number of carbon atoms. For example, (C₁-C₄) hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mᵢ through the formula Mₙ=ΣMᵢnᵢ/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation.

The term “UV light” as used herein refers to ultraviolet light, which is electromagnetic radiation with a wavelength of about 10 nm to about 400 nm.

The term “cure” as used herein refers to exposing to radiation in any form, heating, or allowing to undergo a physical or chemical reaction that results in hardening or an increase in viscosity.

The term “solvent” as used herein refers to a liquid that can dissolve a solid, liquid, or gas. Non-limiting examples of solvents are silicones, organic compounds, water, alcohols, ionic liquids, and supercritical fluids.

The term “coating” as used herein refers to a continuous or discontinuous layer of material on the coated surface, wherein the layer of material can penetrate the surface and can fill areas such as pores, wherein the layer of material can have any three-dimensional shape, including a flat or curved plane. In one example, a coating can be formed on one or more surfaces, any of which may be porous or nonporous, by immersion in a bath of coating material.

The term “surface” as used herein refers to a boundary or side of an object, wherein the boundary or side can have any perimeter shape and can have any three-dimensional shape, including flat, curved, or angular, wherein the boundary or side can be continuous or discontinuous. While the term surface generally refers to the outermost boundary of an object with no implied depth, when the term ‘pores’ is used in reference to a surface, it refers to both the surface opening and the depth to which the pores extend beneath the surface into the substrate.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

Illustrative types of polyethylene include, for example, ultra high molecular weight polyethylene (UHMWPE), ultra low molecular weight polyethylene (ULMWPE), high molecular weight polyethylene (HMWPE), high density polyethylene (HDPE), high density cross-linked polyethylene (HDXLPE), cross-linked polyethylene (PEX or XLPE), medium density polyethylene (MDPE), low density polyethylene (LDPE), linear low density polyethylene (LLDPE) and very low density polyethylene (VLDPE).

1. A method of enhancing hardness of a plastic surface, the method comprising:
coating a surface of a solid plastic form comprising a filler, a polyester, or a combination thereof, with a flowable curable coating composition comprising
a) an alicyclic epoxy group-containing siloxane resin having a weight average molecular weight of about 1,000 to about 4,000 and a (M_{w}/Mₙ) of about 1.05 to about 1.4,
b) an epoxy-functional organosiloxane and an organosiloxane comprising a isocyanate group or an isocyanurate group, or
both a) and b); and
curing the curable coating composition, to provide a hardened film on the solid plastic form surface;
wherein the hardened film on the solid plastic form surface has a hardness of about 3B to about 9H.

2. The method of claim 1, wherein the epoxy-functional organosiloxane has the structure: 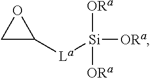
wherein
at each occurrence, R^{a} is independently substituted or unsubstituted (C₁-C₁₀)alkyl,
L^{a} is substituted or unsubstituted (C₁-C₃₀)hydrocarbyl interrupted by 0, 1, 2, or 3 groups independently chosen from —O—, —S—, substituted or unsubstituted —NH—, —(Si(OR^{a})₂)ₙ₁—, —(O—CH₂—CH₂)ₙ₁—, and —(O—CH₂—CH₂—CH₂)ₙ₁—, wherein n1 is about 1 to about 1,000.

3. The method of claim 1, wherein the organosiloxane comprising an isocyanate group has the structure (R^{b})₄₋ₚSi(R^{c})ₚ, wherein
p is 1 to 4,
at each occurrence, R^{b} is independently chosen from substituted or unsubstituted (C₁-C₁₀)alkyl and substituted or unsubstituted (C₁-C₁₀)alkoxy, and
at each occurrence, R^{c} is -L^{b}-NCO, wherein L^{b} is a substituted or unsubstituted (C₁-C₃₀)hydrocarbyl interrupted by 0, 1, 2, or 3 groups independently chosen from —O—, —S—, substituted or unsubstituted —NH—, —(Si(OR^{b})₂)ₙ₂—, —(O—CH₂—CH₂)ₙ₂—, and —(O—CH₂—CH₂—CH₂)ₙ₂—, wherein n2 is about 1 to about 1,000.

4. The method of claim 1, wherein the organosiloxane comprising an isocyanurate group has the structure: 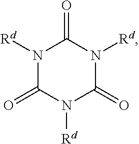
wherein
at each occurrence, R^{d} is chosen from —H and -L^{c}-Si(R^{e})₃, wherein at least one R^{d} is -L^{c}-Si(R^{e})₃,
at each occurrence, L^{c} is independently a substituted or unsubstituted (C₁-C₃₀)hydrocarbyl interrupted by 0, 1, 2, or 3 groups independently chosen from —O—, —S—, substituted or unsubstituted —NH—, —(Si(R^{e})₂)ₙ₃—, —(O—CH₂—CH₂)ₙ₃—, and —(O—CH₂—CH₂—CH₂)ₙ₃—, wherein n3 is about 1 to about 1,000, and
at each occurrence, R^{e} is chosen from substituted or unsubstituted (C₁-C₁₀)alkyl and substituted or unsubstituted (C₁-C₁₀)alkoxy.

5. The method of claim 1, wherein the bis(organosiloxane)-functional amine has the structure R^{f}₃Si-L^{d}-NH-L^{d}-SiR^{f}₃, wherein
at each occurrence, R^{f} is chosen from substituted or unsubstituted (C₁-C₁₀)alkyl and substituted or unsubstituted (C₁-C₁₀)alkoxy, and
at each occurrence, L^{d} is independently a substituted or unsubstituted (C₁-C₃₀)hydrocarbyl interrupted by 0, 1, 2, or 3 groups independently chosen from —O—, —S—, substituted or unsubstituted —NH—, —(Si(R^{f})₂)ₙ₄—, —(O—CH₂—CH₂)ₙ₄—, and —(O—CH₂—CH₂—CH₂)ₙ₄—, wherein n4 is about 1 to about 1,000.

6. The method of claim 1, wherein the siloxane resin is a hydrolysis and condensation reaction product of
(i) an alkoxysilane comprising an alicyclic epoxy group and an alkoxy group having the structure R¹ₙSi(OR²)₄₋ₙ alone, wherein R¹ is (C₃-C₆)cycloalkyl(C₁-C₆)alkyl wherein the cycloalkyl group comprises an epoxy group, R² is (C₁-C₇)alkyl, and n is 1-3, or
(ii) the alkoxysilane having the structure R¹ₙSi(OR²)₄₋ₙ and an alkoxysilane having the structure R³ₘSi(OR⁴)₄₋ₘ, wherein R³ is chosen from (C₁-C₂₀)alkyl, (C₃-C₈)cycloalkyl, (C₂-C₂₀)alkenyl, (C₂-C₂0)alkynyl, (C₆-C₂₀)aryl, an acryl group, a methacyl group, a halogen group, an amino group, a mercapto group, an ether group, an ester group, a carbonayl group, a carboxyl group, a vinyl group, a nitro group, a sulfone group, and an alkyd group, R⁴ is (C₁-C₇)alkyl, and m is 0 to 3,
wherein hydrolysis and condensation reaction is carried out in the presence of water and an optional catalyst.

7. The method of claim 1, wherein the flowable curable coating composition further comprises a reactive monomer capable of reacting with the alicyclic epoxy group to form crosslinking.

8. The method of claim 6, wherein the catalyst is present and is chosen from acidic catalysts, basic catalysts, ion exchange resins, and combinations thereof.

9. The method of claim 1, wherein the hardened film has a thickness of about 1 micrometer to about 100 micrometers.

10. The method of claim 1, wherein the hardened film on the solid plastic form surface has a hardness of about 4H or more.

11. The method of claim 1, wherein the hardened film on the solid plastic form surface has a hardness of about HB to about 8H.

12. The method of claim 1, wherein the solid plastic form comprises at least one of an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN).

13. The method of claim 1, wherein the solid plastic form comprises at least one of polycarbonate polymer (PC) and polymethylmethacrylate polymer (PMMA).

14. The method of claim 1, wherein the filler is about 0.001 wt % to about 50 wt % of the solid plastic form.

15. The method of claim 1, wherein the polyester is about 0.001 wt % to about 50 wt % of the solid plastic form.

16. The method of claim 1, wherein the polyester comprises a repeating unit having the structure: 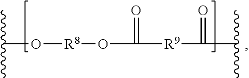
wherein
R⁸ and R⁹ are independently substituted or unsubstituted (C₁-C₂₀)hydrocarbylene.

17. The method of claim 16, wherein R⁸ and R⁹ independently have the structure:

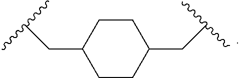 [SMILES: *CC1CCC(C*)CC1]

18. A method of enhancing hardness of a plastic surface, the method comprising:
coating a surface of a solid polycarbonate form comprising glass fibers, a polyester, or a combination thereof, with a flowable curable coating composition, comprising
a) an alicyclic epoxy group-containing siloxane resin having a weight average molecular weight of about 1,000 to about 4,000 and a (M_{w}/Mₙ) of about 1.05 to about 1.4,
b) an epoxy-functional organosiloxane and an organosiloxane comprising a isocyanate group or an isocyanurate group, or
both a) and b); and
curing the curable coating composition, to provide a hardened film on the solid polycarbonate form surface having a hardness of about 3B to about 9H, wherein the solid polycarbonate form is about 50 wt % to about 100 wt % polycarbonate.

19. A solid plastic form having enhanced surface hardness, the plastic form comprising:
a hardened film on a surface of the solid plastic form, the hardened film comprising a cured reaction product of a flowable curable coating composition comprising
a) an alicyclic epoxy group-containing siloxane resin having a weight average molecular weight of about 1,000 to about 4,000 and a (M_{w}/Mₙ) of about 1.05 to about 1.4,
b) an epoxy-functional organosiloxane and an organosiloxane comprising a isocyanate group or an isocyanurate group, or
both a) and b);
wherein the solid plastic form comprises a filler, a polyester, or a combination thereof, and the hardened film on the surface of the solid plastic form has a hardness of about 3B to about 9H.

20. A mobile phone component, a television component, an appliance component, an automobile component, a window, a display film, an anti-scattering film or sheet, or a combination thereof, comprising the plastic form comprising the hardened film of claim 19.
